(19) United States
(12) Patent Application Publication
(10) Pub. No.: US 2026/0067594 A1
(43) Pub. Date: Mar. 5, 2026

(54) DUAL-MODE DIRECT INJECTION (DI) AND BUFFER DIRECT INJECTION (BDI) DIGITAL PIXELS FOR IMAGING DEVICES OR OTHER DEVICES

(71) Applicant: Raytheon Company, Tewksbury, MA (US)

(72) Inventors: Jehyuk Rhee, Newbury Park, CA (US); Bryan W. Kean, Denver, CO (US)

(21) Appl. No.: 18/816,896

(22) Filed: Aug. 27, 2024

(51) Int. Cl. H04N 25/78; H04N 25/77

(52) U.S. Cl. CPC H04N 25/78; H04N 25/77

(57) ABSTRACT

An apparatus includes a transistor configured to receive an electrical current generated by an input source and an integration capacitor configured to receive the electrical current through the transistor and store an electrical charge. The apparatus also includes an amplifier configured to be coupled to the input source and to generate a control signal for a gate of the transistor. The apparatus further includes a comparator configured to compare the stored electrical charge on the integration capacitor to a reference voltage. In addition, the apparatus includes one or more switches configured to adjust an operating mode of the apparatus. In a DI mode, the one or more switches are configured to couple a fixed gate bias voltage to the gate of the transistor. In a BDI mode, the one or more switches are configured to couple the control signal from the amplifier to the gate of the transistor.

### GOVERNMENT RIGHTS

This invention was made with U.S. government support. The government has certain rights in the invention.

### TECHNICAL FIELD

This disclosure relates generally to imaging systems. More specifically, this disclosure relates to dual-mode direct injection (DI) and buffer direct injection (BDI) digital pixels for imaging devices or other devices.

### BACKGROUND

Digital pixels often use integration capacitors and comparators to capture information when generating digital images. For example, an electrical current from a photodetector can be used to charge an integration capacitor, and a comparator can be used to compare the electrical charge stored on the integration capacitor to a reference voltage. Once the electrical charge stored on the integration capacitor meets or exceeds the reference voltage, the integration capacitor can be reset (discharged), and the process can be repeated. The number of times that the integration capacitor is charged to the reference voltage during an image capture operation can be counted and used to generate image data for that pixel. This process can be performed across a number of pixels in an imaging array in order to generate image data for the array.

### SUMMARY

This disclosure relates to dual-mode direct injection (DI) and buffer direct injection (BDI) digital pixels for imaging devices or other devices.

In a first embodiment, an apparatus includes a transistor configured to receive an electrical current generated by an input source and an integration capacitor configured to receive the electrical current through the transistor and store an electrical charge. The apparatus also includes an amplifier configured to be coupled to the input source and to generate a control signal for a gate of the transistor. The apparatus further includes a comparator configured to compare the stored electrical charge on the integration capacitor to a reference voltage. In addition, the apparatus includes one or more switches configured to adjust an operating mode of the apparatus. In a DI mode, the one or more switches are configured to couple a fixed gate bias voltage to the gate of the transistor. In a BDI mode, the one or more switches are configured to couple the control signal from the amplifier to the gate of the transistor.

Any single one or any combination of the following features may be used with the first embodiment. The apparatus may include a counter configured to count pulses generated by the comparator. The apparatus may include at least one additional switch configured to discharge the integration capacitor based on the pulses generated by the comparator or based on a reset signal. The integration capacitor may be configured to be reset by the at least one additional switch at a beginning of an integration period. The counter may be configured to count a number of pulses generated by the comparator during the integration period. The counter may be configured to output a digital value after the integration period ends. The apparatus may include an additional transistor configured to output a residue signal after the integration period ends, and the residue signal may be based on the stored electrical charge on the integration capacitor at an end of the integration period. The transistor, integration capacitor, amplifier, comparator, and one or more switches may form at least part of a module that is configured to be coupled to different types of input sources including different types of photodetectors. One or more voltages used by the module may be optimized based on at least one of: a specific type of input source coupled to the module or a specific application for the module. The module may be configured to be coupled to a common readout integrated circuit regardless of a specific type of input source coupled to the module. The input source may include a photodetector configured to generate the electrical current based on received illumination.

In a second embodiment, a system includes a focal plane array having multiple pixel circuit elements. Each pixel circuit element includes a photodetector configured to generate an electrical current based on received illumination and a transistor configured to receive the electrical current from the photodetector. Each pixel circuit element also includes an integration capacitor configured to receive the electrical current through the transistor and store an electrical charge and an amplifier coupled to the photodetector and configured to generate a control signal for a gate of the transistor. Each pixel circuit element further includes a comparator configured to compare the stored electrical charge on the integration capacitor to a reference voltage and one or more switches configured to adjust an operating mode of the pixel circuit element. In a DI mode, the one or more switches are configured to couple a fixed gate bias voltage to the gate of the transistor. In a BDI mode, the one or more switches are configured to couple the control signal from the amplifier to the gate of the transistor.

Any single one or any combination of the following features may be used with the second embodiment. Each pixel circuit element may include a counter configured to count pulses generated by the comparator. Each pixel circuit element may include at least one additional switch configured to discharge the integration capacitor based on the pulses generated by the comparator or based on a reset signal. For each pixel circuit element, the integration capacitor may be configured to be reset by the at least one additional switch at a beginning of an integration period. For each pixel circuit element, the counter may be configured to count a number of pulses generated by the comparator during the integration period. For each pixel circuit element, the counter may be configured to output a digital value after the integration period ends. Each pixel circuit element may include an additional transistor configured to output a residue signal after the integration period ends, and the residue signal may be based on the stored electrical charge on the integration capacitor at an end of the integration period. The transistor, integration capacitor, amplifier, comparator, and one or more switches of each pixel circuit element may form at least part of at least one module configured to be coupled to different types of photodetectors. One or more voltages used by each module may be optimized based on at least one of: a specific type of photodetector coupled to the module or a specific application for the module. The system may include a readout integrated circuit coupled to multiple pixel circuit elements. The system may include one or more controllers configured to control operation of the pixel circuit elements, including the operating mode of each pixel circuit element. The system may include a data processing system configured to process output signals from the focal plane array and generate one or more images of a scene.

In a third embodiment, a method includes receiving an electrical current from an input source and passing the electrical current through a transistor to an integration capacitor. The method also includes integrating the electrical current using the integration capacitor to generate an integration voltage and comparing the integration voltage and a reference voltage using a comparator. The method further includes discharging the integration capacitor in response to the integration voltage meeting or exceeding the reference voltage and controlling one or more switches to set an operating mode used to integrate the electrical current. In a DI mode, the one or more switches couple a fixed gate bias voltage to a gate of the transistor. In a BDI mode, the one or more switches are configured to couple a control signal from an amplifier to the gate of the transistor, the amplifier coupled to the input source.

Any single one or any combination of the following features may be used with the third embodiment. The method may include counting pulses generated based on the comparing of the integration voltage and the reference voltage. The method may include outputting a digital value based on the counted pulses after an integration period ends. The method may include outputting a residue signal after the integration period ends, the residue signal based on the integration voltage on the integration capacitor at an end of the integration period. A module may include the transistor, integration capacitor, amplifier, comparator, and one or more switches. The module may be configured to be coupled to different types of input sources including different types of photodetectors. The module may be configured to be coupled to a common readout integrated circuit regardless of a specific type of input source coupled to the module. One or more voltages used by the module may be optimized based on at least one of: a specific type of input source coupled to the module or a specific application for the module. The input source may include a photodetector that generates the electrical current based on received illumination.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example system supporting dual-mode direct injection (DI) and buffer direct injection (BDI) digital pixels for an imaging device or other device according to this disclosure;

FIG. 2 illustrates an example circuit supporting a dual-mode DI and BDI digital pixel for an imaging device or other device according to this disclosure;

FIG. 3 illustrates an example timing diagram associated with the circuit of FIG. 2 according to this disclosure; and

FIG. 4 illustrates an example method for using dual-mode DI and BDI digital pixels in an imaging device or other device according to this disclosure.

### DETAILED DESCRIPTION

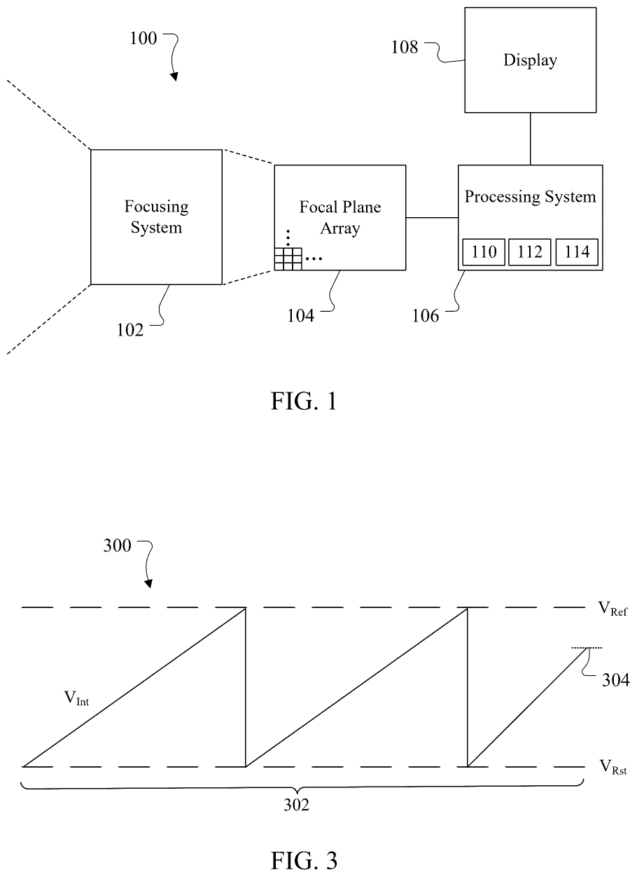

FIGS. 1 through 4, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, digital pixels often use integration capacitors and comparators to capture information when generating digital images. For example, an electrical current from a photodetector can be used to charge an integration capacitor, and a comparator can be used to compare the electrical charge stored on the integration capacitor to a reference voltage. Once the electrical charge stored on the integration capacitor meets or exceeds the reference voltage, the integration capacitor can be reset (discharged), and the process can be repeated. The number of times that the integration capacitor is charged to the reference voltage during an image capture operation can be counted and used to generate image data for that pixel. This process can be performed across a number of pixels in an imaging array in order to generate image data for the array.

Digital pixels of various designs have been developed, some of which differing in how they charge an integration capacitor during a sampling interval. Direct injection (DI) digital pixels can be suitable for use in lower-power systems or with higher-impedance detectors and for use with higher input currents, such as when scenes being imaged have higher relatively-uniform flux levels, and DI digital pixels can handle larger voltage swings. In some cases, DI digital pixels can be used with strained-layer superlattice (SLS) detectors or detectors like mid-wave infrared (MWIR) detectors having wider bias ranges. The injection efficiency of a DI digital pixel can be more dependent on its input current and detector resistance, and the detector bias of a DI digital pixel can be more dependent on its input current.

Buffer direct injection (BDI) digital pixels can be suitable for use in higher-power systems or with lower-impedance detectors and for use with lower input currents, such as when scenes being imaged have flux levels that vary significantly over the scenes, and BDI digital pixels can handle smaller voltage swings. In some cases, BDI digital pixels can be used with mercury cadmium telluride (HgCdTe) detectors or detectors like long-wave infrared (LWIR) detectors having narrower bias ranges. The injection efficiency of a BDI digital pixel can be less dependent on its input current and detector resistance, and the detector bias of a BDI digital pixel can be less dependent on its input current.

This disclosure provides circuits that support dual-mode DI and BDI digital pixels for imaging devices or other devices. As described in more detail below, a pixel circuit element may include or be configured to be coupled to a photodetector that is configured to generate an electrical current based on received illumination. The pixel circuit element may also include an integration capacitor and a DI transistor configured to provide the electrical current to the integration capacitor in order to charge the integration capacitor. The pixel circuit element may further include a BDI amplifier coupled to the photodetector and configured to generate a control signal for a gate of the DI transistor. The pixel circuit element may also include a comparator configured to compare a stored electrical charge on the integration capacitor to a reference voltage. In addition, the pixel circuit element may include one or more switches configured to adjust an operating mode of the pixel circuit element. In a DI operating mode, the one or more switches may couple a fixed gate bias voltage to the gate of the DI transistor. In a BDI operating mode, the one or more switches may couple the control signal from the BDI amplifier to the gate of the DI transistor. A counter may be used to count pulses generated by the comparator, and the pulses from the comparator can be used to trigger discharge of the integration capacitor. At least one additional switch may be coupled across the capacitor and selectively closed to discharge the capacitor, such as in response to a reset signal or in response to the pulses generated by the comparator. The pixel circuit element may be replicated any number of times for use in an imaging device or other device, such as when multiple pixel circuit elements are used in a focal plane array.

In this way, each of one or more pixel circuit elements in an imaging device or other device may be selectively configured to operate in DI mode or BDI mode. As a result, each pixel circuit element can be optimized for a wide range of background flux and can be electrically switchable between modes. Because of this, the operating mode of each pixel circuit element can be adjusted as needed or desired, such as based on the type of detector technology being used. In some cases, this may allow a modular approach to be developed in which the same circuitry can be used with different types of photodetectors. Moreover, it becomes possible for the same circuitry to be optimized for use with different types of photodetectors or for use in different types of applications, such as when detector, analog, or other bias voltages can be optimized for a given type of photodetector or for a given application. Further, it is possible to effectively turn off the BDI amplifier when the DI operating mode is being used, which can help to reduce power consumption. In addition, each individual pixel circuit element in an imaging device or other device may be configurable to operate in DI mode or BDI mode, which differs from some approaches that force each pair of pixel elements to have one pixel element operating in DI mode and another pixel element operating in BDI mode.

Imaging systems designed in accordance with this disclosure may be used in any suitable applications. For example, imaging systems designed in accordance with this disclosure may be used in digital cameras, video recorders, smartphones, or other electronic devices that can be used to capture still or video images. Imaging systems designed in accordance with this disclosure may be used in commercial and defense-related satellites, aircraft, and drones, such as to produce visible, infrared, or other images of scenes. Imaging systems designed in accordance with this disclosure may be used in robotic systems or other systems intended for use in surgical or industrial settings, such as to generate images of patients undergoing treatment or images of components being fabricated or processed. Imaging systems designed in accordance with this disclosure may be used in medical imaging systems, such as to produce images of patients. In general, the imaging systems designed in accordance with this disclosure may be used in any suitable applications.

FIG. 1 illustrates an example system 100 supporting dual-mode DI and BDI digital pixels for an imaging device or other device according to this disclosure. As shown in FIG. 1, the system 100 includes a focusing system 102, a focal plane array 104, and a processing system 106. The focusing system 102 generally operates to focus illumination from a scene onto the focal plane array 104. The focusing system 102 may have any suitable field of view that is directed onto the focal plane array 104. The focusing system 102 includes any suitable structure(s) configured to focus illumination, such as one or more lenses, mirrors, or other optical devices.

The focal plane array 104 generally operates to capture image data related to a scene. For example, the focal plane array 104 may include a matrix or other collection of pixel circuit elements that generate electrical signals representing a scene and that process the electrical signals. Several of the pixel circuit elements are shown in FIG. 1, although the size of the pixel circuit elements is exaggerated for convenience here. The focal plane array 104 may capture image data in any suitable spectrum or spectra, such as in the visible, infrared, or ultraviolet spectrum. The focal plane array 104 may also have any suitable resolution, such as when the focal plane array 104 includes a collection of approximately 1,000 pixel circuit elements by approximately 1,000 pixel circuit elements (although other collection sizes may be used). The focal plane array 104 includes any suitable collection of pixel circuit elements configured to capture image data. The focal plane array 104 may also include additional components that facilitate the receipt and output of information, such as readout integrated circuits (ROICs).

As described in more detail below, the pixel circuit elements of the focal plane array 104 include photodetectors (such as photodiodes) that capture illumination from a scene and generate electrical currents. For each pixel circuit element, the electrical current can be integrated by circuitry operating in DI mode or BDI mode, depending on the configuration of the pixel circuit element. For example, when operating in DI mode, a DI transistor provides the electrical current to an integration capacitor, and the DI transistor receives a fixed gate bias voltage at its gate. When operating in BDI mode, the DI transistor provides the electrical current to the integration capacitor, and an amplifier generates a control signal based on the electrical current and provides the control signal to the gate of the DI transistor. In either mode, the electrical current provided by the DI transistor can be used to charge the integration capacitor, and a comparator can compare a stored charge on the integration capacitor to a reference voltage. The comparator can reset the integration capacitor when the stored charge on the integration capacitor meets or exceeds the reference voltage, and a counter may count the number of times that the comparator resets the integration capacitor during a sampling interval. The counter can output a digital count value, which can be used to generate image data for the pixel circuit element. Additional circuitry in each pixel circuit element may optionally be used to generate a residue analog signal, which can represent the stored charge remaining on the integration capacitor at an end of the sampling interval and which can also be used to generate image data for the pixel circuit element.

The processing system 106 receives outputs from the focal plane array 104 and processes the information. For example, the processing system 106 may process image data generated by the focal plane array 104 in order to generate visual images for presentation to one or more personnel, such as on a display 108. However, the processing system 106 may use the image data generated by the focal plane array 104 in any other suitable manner. The processing system 106 includes any suitable structure configured to process information from a focal plane array or other imaging system. For instance, the processing system 106 may include one or more processing devices 110, such as one or more microprocessors, microcontrollers, digital signal processors (DSPs), field programmable gate arrays (FPGAs), application specific integrated circuits (ASICs), or discrete logic devices. The processing system 106 may also include one or more memories 112, such as a random access memory, read only memory, hard drive, Flash memory, optical disc, or other suitable volatile or non-volatile storage device(s). The processing system 106 may further include one or more interfaces 114 that support communications with other systems or devices, such as a network interface card or a wireless transceiver facilitating communications over a wired or wireless network or a direct connection. The display 108 includes any suitable device configured to graphically present information.

Although FIG. 1 illustrates one example of a system 100 supporting dual-mode DI and BDI digital pixels for an imaging device or other device, various changes may be made to FIG. 1. For example, various components in FIG. 1 may be combined, further subdivided, replicated, omitted, or rearranged and additional components may be added according to particular needs. Also, FIG. 1 illustrates one example type of system in which dual-mode DI and BDI digital pixels may be used. However, dual-mode DI and BDI digital pixels may be used in any other suitable device or system.

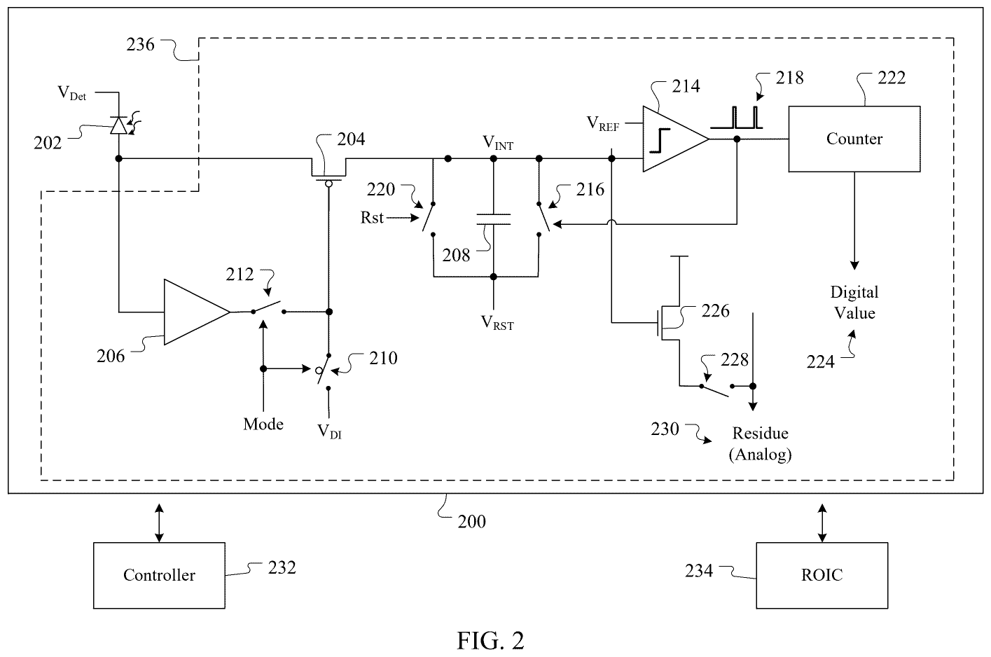

FIG. 2 illustrates an example circuit 200 supporting a dual-mode DI and BDI digital pixel for an imaging device or other device according to this disclosure. An instance of the circuit 200 shown in FIG. 2 may, for example, represent (or be used as at least part of) each pixel circuit element of the focal plane array 104 in the system 100 shown in FIG. 1. Thus, different pixel circuit elements of the focal plane array 104 may include different instances of the circuit 200 shown in FIG. 2. However, any number of the circuits 200 may be used with any other suitable device and in any other suitable system.

As shown in FIG. 2, the circuit 200 includes a photodetector 202, which generally operates to produce an electrical current based on received illumination. The photodetector 202 includes any suitable structure configured to generate an electrical current based on received illumination, such as a photodiode. In some cases, the photodetector 202 may represent a photodiode or other structure that can sense illumination in a specified wavelength range or band, such as in the visible, infrared, or ultraviolet spectrum. The photodetector 202 here is coupled to receive a detector voltage V_{Det}, which may be provided by any suitable voltage source.

The photodetector 202 is coupled to a DI transistor 204 and a BDI amplifier 206. The DI transistor 204 is coupled to an integration capacitor 208 and can provide the electrical current from the photodetector 202 to charge the integration capacitor 208. The DI transistor 204 is controlled using a gate bias voltage applied to a gate of the DI transistor 204. The DI transistor 204 represents any suitable transistor that can provide electrical current. In this example, the DI transistor 204 represents a p-type metal oxide semiconductor (PMOS), although other types of transistors may be used here. The BDI amplifier 206 can generate a control signal representing a gate bias voltage, which can be selectively applied to the gate of the DI transistor 204. The gate bias voltage generated by the BDI amplifier 206 can be based on a voltage generated at an output of the photodetector 202. The BDI amplifier 206 includes any suitable structure configured to amplify a voltage. The integration capacitor 208 represents any suitable capacitive structure having any suitable capacitance.

One or more switches are used to control whether the circuit 200 operates in DI mode or BDI mode. In this example, a switch 210 can be used to selectively couple an external gate bias voltage V_{DI} to the gate of the DI transistor 204, and a switch 212 can be used to selectively couple an output of the BDI amplifier 206 to the gate of the DI transistor 204. The switches 210 and 212 may be controlled by a common control signal Mode, where the Mode signal is inverted for one of the switches 210 and 212. This allows one switch 210 or 212 to be opened while the other switch 212 or 210 is closed. More specifically, the switch 210 can be closed and the switch 212 can be opened when operating in DI mode, and the switch 212 can be closed and the switch 210 can be opened when operating in BDI mode. Note, however, that separate control signals for the two switches 210 and 212 may be generated and used here. Also note that when the switch 212 is opened, the BDI amplifier 206 may be turned off in order to reduce power consumption in the circuit 200. Each switch 210 and 212 includes any suitable structure configured to selectively form and break an electrical connection, such as a transistor.

In this example, the integration capacitor 208 integrates the electrical current from the photodetector 202 by storing an electrical charge, where the stored electrical charge is said to represent an integration voltage V_{INT}. A comparator 214 compares the integration voltage V_{INT} to a reference voltage V_{REF}, which may be provided by any suitable voltage source. When the comparator 214 determines that the integration voltage V_{INT} equals or exceeds the reference voltage V_{REF}, the comparator 214 can toggle its output, such as by changing from outputting a low logic value to a high logic value.

A switch 216 can be coupled across the integration capacitor 208 and can be controlled based on an output of the comparator 214. When the comparator 214 toggles its output, such as to a high logic value, the switch 216 can close, which causes the integration capacitor 208 to discharge until the voltage stored on the integration capacitor 208 reaches a reset voltage V_{RST}. The reset voltage V_{RST} may be provided by any suitable voltage source or may represent an electrical ground. The discharging of the integration capacitor 208 lowers the integration voltage V_{INT}, and the comparator 214 can then toggle its output again, such as by changing from outputting a high logic value to a low logic value, since the integration voltage V_{INT} no longer meets or exceeds reference voltage V_{REF}. The second toggling at the output of the comparator 214 can cause the switch 216 to open, which allows the integration capacitor 208 to again be charged by the electrical current from the photodetector 202. These toggles by the comparator 214 can produce a series of pulses 218 in the output of the comparator 214.

A switch 220 can also be coupled across the integration capacitor 208 and can be used to reset the integration capacitor 208, such as at the beginning of an integration period. Here, the switch 220 is controlled using a control signal Rst. The comparator 214 includes any suitable structure configured to compare electrical voltages. Each switch 216 and 220 includes any suitable structure configured to selectively form and break an electrical connection, such as a transistor.

A counter 222 can be used to count the number of pulses 218 in the output of the comparator 214 during an integration period. For example, the counter 222 may be reset at the begging of the integration period, and the counter 222 can increment its count value in response to each pulse 218. At the end of the integration period, a digital value 224 can be output from the counter 222, where the digital value 224 represents the number of pulses 218 counted during the integration period. The digital value 224 therefore represents the number of times that the integration voltage V_{INT} of the integration capacitor 208 met or exceeded the reference voltage V_{REF} during the integration period. When the photodetector 202 receives more illumination, the photodetector 202 produces a larger electrical current, which charges the integration capacitor 208 faster and causes the integration capacitor 208 to be reset more often during the integration period. When the photodetector 202 receives less illumination, the photodetector 202 produces a smaller electrical current, which charges the integration capacitor 208 slower and causes the integration capacitor 208 to be reset less often or not at all during the integration period. Thus, the digital value 224 generated by the counter 222 can be used to generate image data for the circuit 200. The counter 222 includes any suitable structure configured to count pulses 218, such as an n-bit digital counter.

The integration capacitor 208 may be partially charged at the end of an integration period, which can occur when the integration capacitor 208 is reset but has not charged to the point where the integration voltage V_{INT} stored on the integration capacitor 208 meets or exceeds the reference voltage V_{REF}. In that case, the integration voltage V_{INT} stored on the integration capacitor 208 at the end of the integration period can provided to a gate of a transistor 226, which can be coupled between a voltage line and a switch 228. The switch 228 can be closed (such as after the integration period has ended) so that a measure of the integration voltage V_{INT} stored on the integration capacitor 208 can be output as a residue signal 230, which can represent an analog signal. The residue signal 230 can therefore also be used to generate image data for the circuit 200, where the residue signals 230 and the digital values 224 together may be used to produce more-precise image data than using the digital values 224 alone.

In one aspect of operation, one of the switches 210 and 212 can be opened and the other of the switches 210 and 212 can be closed based on the Mode signal, depending on whether the circuit 200 operates in DI mode or BDI mode. In either case, the circuit 200 can be reset at the beginning of an integration period by closing the switch 220 based on the Rst signal, which resets the integration voltage V_{INT} stored on the integration capacitor 208 to the reset voltage V_{RST}. After resetting, the switch 220 can be opened at the beginning of the integration period, and the integration capacitor 208 can be charged based on the electrical current from the photodetector 202 to generate the integration voltage V_{INT}. The generation of the integration voltage V_{INT} can vary depending on whether the circuit 200 is operating in DI mode or BDI mode. The integration capacitor 208 may be reset one or more times based on the comparator 214 comparing the integration voltage V_{INT} to the reference voltage V_{REF} and closing and then opening the switch 216 to reset the integration voltage V_{INT} to the reset voltage V_{RST}. The number of pulses 218 generated by the comparator 214 can be counted by the counter 222. After the integration period ends, the digital value 224 can be read from the counter 222, and the residue signal 230 associated with the remaining integration voltage V_{INT} can be output. If another integration period is to occur, the reset signal Rst can be asserted to reset the circuit 200, and the next integration period can occur in the same manner as described above.

Note that the circuit 200 can be replicated any number of times in an imaging device or other device. For example, the circuit 200 can be replicated to form any number of pixel circuit elements in a focal plane array 104 or other device. In some cases, the counters 222 of multiple circuits 200 can be coupled to a common signal line (such as by using additional switches between the counters 222 and the common signal line), which allows the counters 222 of the multiple circuits 200 to output their digital values 224 to be read over the same signal line. Similarly, the switches 228 of the multiple circuits 200 can be coupled to a common signal line, which allows the residue signals 230 of the multiple circuits 200 to be read over the same signal line.

A controller 232 may be used to control the configuration or other operations of various components in the circuit 200. For example, the controller 232 may be used to generate drive signals for controlling the states of the various switches 210, 212, 220, 228. As a particular example, the controller 232 can generate the Mode signal to control whether the circuit 200 operates in DI mode or BDI mode. Note that the same controller 232 may be used to control components in different instances of the circuit 200 or different controllers 232 may be used to control components in different instances of the circuit 200. Each controller 232 includes any suitable structure configured to control operation of one or more components of one or more circuits 200. For example, each controller 232 may represent at least one microprocessor, microcontroller, DSP, FPGA, ASIC, logic gates, or discrete circuitry.

One or more readout integrated circuits (ROICs) 234 can be used to receive data from one or more circuits 200 and to provide the data to one or more external destinations, such as the processing system 106. For example, the one or more ROICs 234 may be used to provide digital values 224 from one or more circuits 200 to the processing system 106 or other destination(s). The one or more ROICs 234 may also be used to provide the residue signals 230 from one or more circuits 200 to the processing system 106 or other destination(s) or to digitize the residue signals 230 and provide the digitized residue signals 230 to the processing system 106 or other destination(s). Note that the same ROIC 234 may be used with different instances of the circuit 200 or different ROIC 234 may be used with different instances of the circuit 200.

As described above, this type of design may support the use of a modular approach for an imaging device or other device. For example, all components of the circuit 200 except for the photodetector 202 may be implemented as a module 236, and the module 236 may include components from one or multiple instances of the circuit 200. The module 236 can be coupled to various types of photodetectors 202, thereby allowing the same module 236 to be reusable regardless of the type of photodetector 202 being used. This may also allow the same ROIC(s) 234 to be used, regardless of the type of photodetector 202 being used. As another example, various voltages used in the circuit 200 could be customized or optimized for use with different types of photodetectors 202 or for use in different applications. Thus, for instance, the detector voltage V_{Det}, the gate bias voltage V_{DI}, the reset voltage V_{RST}, and/or the reference voltage V_{REF} can be customized or optimized for use with a specific type of photodetector 202 or for use in a specific application.

Although FIG. 2 illustrates one example of a circuit 200 supporting a dual-mode DI and BDI digital pixel for an imaging device or other device, various changes may be made to FIG. 2. For example, any additional components may be used with the circuit 200 to support other desired functions. Also, circuit elements shown in FIG. 2 may be replaced by other circuit elements performing the same or similar function. As a particular example, the switches 210 and 212 may be implemented using a single switch, where (i) one end of the single switch is coupled to the gate of the DI transistor 204 and (ii) the other end of the single switch is controllable and can be coupled to either the BDI amplifier 206 or the gate bias voltage V_{DI}. Similarly, the switches 216 and 220 may be replaced by the single switch coupled across the capacitor 208, where the single switch can be closed based on either (i) a pulse in the reset signal Rst or (ii) a pulse in the output of the comparator 214. In addition, while the photodetector 202 in this examples provides an electrical current used by the circuit 200, the electrical current may be received from any other suitable input source.

FIG. 3 illustrates an example timing diagram 300 associated with the circuit 200 of FIG. 2 according to this disclosure. As shown in FIG. 3 and described above, during an integration period 302, the integration capacitor 208 may be charged and discharged one or more times. This is shown as the integration voltage V_{INT} increasing due to charging of the integration capacitor 208 by the electrical current from the photodetector 202 until the integration voltage V_{INT} reaches or exceeds the reference voltage V_{REF}. At that point the integration capacitor 208 is discharged, and the integration voltage V_{INT} is reset to the reset voltage V_{RST}. At the end of the integration period 302, the counter 222 can output a digital value 224 representing the number of times that the integration capacitor 208 was reset. Optionally, a residue voltage 304 remaining on the integration capacitor 208 can be output as a residue signal 230.

Note that the behavior shown in the timing diagram 300 here can hold whether the circuit 200 operates in DI mode or BDI mode, but the charging and discharging behavior of the integration capacitor 208 can vary depending on the mode. In other words, how the integration voltage V_{INT} increases may differ depending on the mode, but the integration voltage V_{INT} can still generally increase until reaching or exceeding the reference voltage V_{REF} and then be reset to the reset voltage V_{RST} in either mode.

Although FIG. 3 illustrates one example of a timing diagram 300 associated with the circuit 200 of FIG. 2, various changes may be made to FIG. 3. For example, the number of times that the integration capacitor 208 is reset and the residue voltage 304 remaining can vary based on a number of factors, such as the length of the integration period 302 and the amount of illumination received at the photodetector 202.

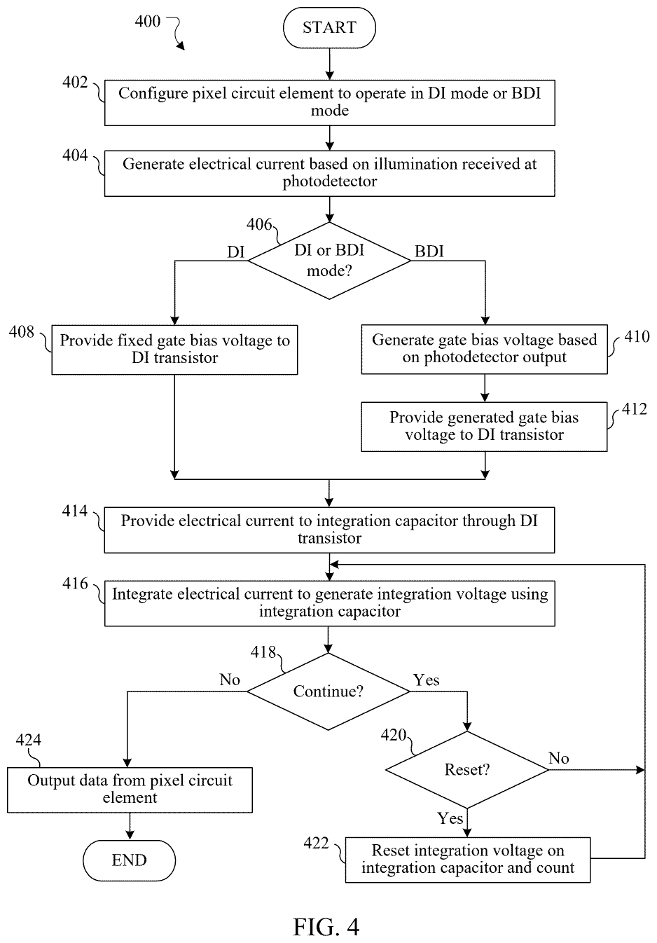

FIG. 4 illustrates an example method 400 for using dual-mode DI and BDI digital pixels in an imaging device or other device according to this disclosure. For ease of explanation, the method 400 shown in FIG. 4 is described as being performed using the circuit 200 shown in FIG. 2 in the system 100 shown in FIG. 1. However, the method 400 may be performed using any other suitable circuit and in any other suitable system.

As shown in FIG. 4, a pixel circuit element is configured to operate in DI mode or BDI mode at step 402. This may include, for example, the controller 232 opening one switch 210 or 212 and closing the other switch 212 or 210 of the circuit 200. The determination of which operating mode to use can be based on any suitable criterion or criteria. For instance, the operating mode used could be based on the contents of the scene being imaged, the specific type of photodetector 202 being used, or the specific application in which the circuit 200 is being used. In some cases, the operating mode may be predefined, such as when the selected operating mode or the correct setting of the switches 210, 212 is stored in a memory of the controller 232 beforehand.

An electrical current is generated based on illumination received at the photodetector of the pixel circuit element at step 404. This may include, for example, the photodetector 202 generating an electrical current based on received illumination. If the pixel circuit element is operating in DI mode at step 406, a fixed gate bias voltage is provided to the gate of a DI transistor at step 408. This may include, for example, the switch 210 passing the gate bias voltage V_{DI} to the gate of the DI transistor 204. Otherwise, a gate bias voltage for the DI transistor is generated based on the output of the photodetector at step 410, and the generated gate bias voltage is provided to the gate of the DI transistor at step 412. This may include, for example, the BDI amplifier 206 amplifying the voltage at an output of the photodetector 202 and the switch 212 passing the generated gate bias voltage to the gate of the DI transistor 204.

The electrical current from the photodetector is provided to an integration capacitor through the DI transistor at step 414. This may include, for example, the DI transistor 204 passing the electrical current from the photodetector 202 to the integration capacitor 208 under the control of the fixed gate bias voltage or the generated gate bias voltage. The electrical current is integrated to generate an integration voltage using the integration capacitor at step 416. This may include, for example, the integration capacitor 208 charging based on the electrical current received from the photodetector 202 through the DI transistor 204.

A determination is made whether to continue the process at step 418. This may include, for example, the controller 232 determining whether an integration period has ended. If the determination is made to continue, a determination is made whether to reset the integration voltage on the integration capacitor at step 420. This may include, for example, the comparator 214 comparing the integration voltage V_{INT} stored on the integration capacitor 208 to the reference voltage V_{REF}. If the integration capacitor does not need to be reset, the process can return to step 416 to continue charging the integration capacitor 208. Otherwise, the integration voltage on the integration capacitor is reset and the instance is counted at step 422. This may include, for example, the comparator 214 toggling its output to close the switch 216 coupled across the integration capacitor 208 in order to reset the integration voltage V_{INT} to the reset voltage V_{RST}. This may also include the comparator 214 toggling its output again to open the switch 216. This may further include the counter 222 counting the resulting pulse 218 in the output of the comparator 214. Again, the process can return to step 416 to continue charging the integration capacitor 208.

If the determination is made not to continue at step 418, data from the pixel circuit element is output at step 424. This may include, for example, the circuit 200 outputting the digital value 224 from the counter 222 and optionally the residue signal 230 to an external device or system for use. The digital value 224 and the optional residue signal 230 may represent or be used to generate image data. The image data can be used in any suitable manner, such as to generate an image of a scene.

Although FIG. 4 illustrates one example of a method 400 for using dual-mode DI and BDI digital pixels in an imaging device or other device, various changes may be made to FIG. 4. For example, while shown as a series of steps, various steps in FIG. 4 may overlap, occur in parallel, occur in a different order, or occur any number of times (including zero times). Also, the method 400 may be performed across any number of pixel circuit elements, such as when the method 400 is performed for each pixel circuit element in a focal plane array 104.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a transistor configured to receive an electrical current generated by an input source;
an integration capacitor configured to receive the electrical current through the transistor and store an electrical charge;
an amplifier configured to be coupled to the input source and to generate a control signal for a gate of the transistor;
a comparator configured to compare the stored electrical charge on the integration capacitor to a reference voltage; and
one or more switches configured to adjust an operating mode of the apparatus;
wherein, in a direct injection (DI) mode, the one or more switches are configured to couple a fixed gate bias voltage to the gate of the transistor; and
wherein, in a buffer direct injection (BDI) mode, the one or more switches are configured to couple the control signal from the amplifier to the gate of the transistor.

2. The apparatus of claim 1, further comprising:
a counter configured to count pulses generated by the comparator; and
at least one additional switch configured to discharge the integration capacitor based on the pulses generated by the comparator or based on a reset signal.

3. The apparatus of claim 2, wherein:
the integration capacitor is configured to be reset by the at least one additional switch at a beginning of an integration period;
the counter is configured to count a number of pulses generated by the comparator during the integration period; and
the counter is configured to output a digital value after the integration period ends.

4. The apparatus of claim 3, further comprising:
an additional transistor configured to output a residue signal after the integration period ends, the residue signal based on the stored electrical charge on the integration capacitor at an end of the integration period.

5. The apparatus of claim 1, wherein the transistor, integration capacitor, amplifier, comparator, and one or more switches form at least part of a module that is configured to be coupled to different types of input sources including different types of photodetectors.

6. The apparatus of claim 5, wherein the module is configured to be coupled to a common readout integrated circuit regardless of a specific type of input source coupled to the module.

7. The apparatus of claim 1, wherein, in the DI mode, the one or more switches are further configured to turn off the amplifier.

8. The apparatus of claim 1, wherein the input source comprises a photodetector configured to generate the electrical current based on received illumination.

9. A system comprising:
a focal plane array comprising multiple pixel circuit elements;
wherein each pixel circuit element comprises:
a photodetector configured to generate an electrical current based on received illumination;
a transistor configured to receive the electrical current from the photodetector;
an integration capacitor configured to receive the electrical current through the transistor and store an electrical charge;
an amplifier coupled to the photodetector and configured to generate a control signal for a gate of the transistor;
a comparator configured to compare the stored electrical charge on the integration capacitor to a reference voltage; and
one or more switches configured to adjust an operating mode of the pixel circuit element;
wherein, in a direct injection (DI) mode, the one or more switches are configured to couple a fixed gate bias voltage to the gate of the transistor; and
wherein, in a buffer direct injection (BDI) mode, the one or more switches are configured to couple the control signal from the amplifier to the gate of the transistor.

10. The system of claim 9, wherein each pixel circuit element further comprises:
a counter configured to count pulses generated by the comparator; and
at least one additional switch configured to discharge the integration capacitor based on the pulses generated by the comparator or based on a reset signal.

11. The system of claim 10, wherein, for each pixel circuit element:
the integration capacitor is configured to be reset by the at least one additional switch at a beginning of an integration period;
the counter is configured to count a number of pulses generated by the comparator during the integration period; and
the counter is configured to output a digital value after the integration period ends.

12. The system of claim 11, wherein each pixel circuit element further comprises an additional transistor configured to output a residue signal after the integration period ends, the residue signal based on the stored electrical charge on the integration capacitor at an end of the integration period.

13. The system of claim 9, wherein the transistor, integration capacitor, amplifier, comparator, and one or more switches of each pixel circuit element form at least part of at least one module configured to be coupled to different types of photodetectors.

14. The system of claim 13, further comprising:
a readout integrated circuit coupled to multiple pixel circuit elements.

15. The system of claim 9, wherein, in the DI mode, the one or more switches of each pixel circuit element are further configured to turn off the amplifier of the pixel circuit element.

16. The system of claim 9, further comprising at least one of:
one or more controllers configured to control operation of the pixel circuit elements, including the operating mode of each pixel circuit element; or
a data processing system configured to process output signals from the focal plane array and generate one or more images of a scene.

17. A method comprising:
receiving an electrical current from an input source;
passing the electrical current through a transistor to an integration capacitor;
integrating the electrical current using the integration capacitor to generate an integration voltage;
comparing the integration voltage and a reference voltage using a comparator;
discharging the integration capacitor in response to the integration voltage meeting or exceeding the reference voltage; and
controlling one or more switches to set an operating mode used to integrate the electrical current;
wherein, in a direct injection (DI) mode, the one or more switches couple a fixed gate bias voltage to a gate of the transistor; and
wherein, in a buffer direct injection (BDI) mode, the one or more switches are configured to couple a control signal from an amplifier to the gate of the transistor, the amplifier coupled to the input source.

18. The method of claim 17, further comprising:
counting pulses generated based on the comparing of the integration voltage and the reference voltage;
outputting a digital value based on the counted pulses after an integration period ends; and
outputting a residue signal after the integration period ends, the residue signal based on the integration voltage on the integration capacitor at an end of the integration period.

19. The method of claim 17, wherein:
a module includes the transistor, integration capacitor, amplifier, comparator, and one or more switches;
the module is configured to be coupled to different types of input sources including different types of photodetectors; and
the module is configured to be coupled to a common readout integrated circuit regardless of a specific type of input source coupled to the module.

20. The method of claim 17, wherein the input source comprises a photodetector that generates the electrical current based on received illumination.
